(19) United States
(12) Patent Application Publication
(10) Pub. No.: US 2013/0248601 A1
(43) Pub. Date: Sep. 26, 2013

(54) MOBILE COMPUTER WITH INTEGRATED NEAR FIELD COMMUNICATION ANTENNA

(71) Applicants: Xiaotao Liang, East Northport, NY (US); Mark C. Palmer, Bay Shore, NY (US); Timothy B. Zelinski, Sayville, NY (US)

(72) Inventors: Xiaotao Liang, East Northport, NY (US); Mark C. Palmer, Bay Shore, NY (US); Timothy B. Zelinski, Sayville, NY (US)

(73) Assignee: Symbol Technologies, Inc., Holtsville, NY (US)

(21) Appl. No.: 13/429,639

(22) Filed: Mar. 26, 2012

(51) Int. Cl. G06K 7/00

(52) U.S. Cl. 235/440

(57) ABSTRACT

A mobile computer is described. The mobile computer includes a memory for storing a software application. A processor is coupled to the memory for executing the software application. A display is coupled to the processor for graphically displaying information generated by the software application. A card reader having a slot is coupled to the processor for receiving input from a data card. A radio frequency identification (RFID) antenna is embedded in a portion of the card reader proximate to the slot. The RFID antenna includes at least one conductor that forms at least one loop for communicating with an RFID device positioned at least partially within the slot.

### TECHNICAL FIELD

The invention relates generally to a mobile computer having a near field communication (NFC) radio antenna integrated in a data card reader module, such as a magnetic stripe reader (MSR) module.

### BACKGROUND

Mobile computing terminals having integrated near field communication NFC technologies allow users to bring objects having RFID tags proximate to the terminal in order to read information contained within the tag or write information to the tag. However, the tag must be placed within a few millimeters of the typical NFC antenna in order to be read/write since the antenna cannot generate sufficient field strength to communicate with RFID tags placed further away. Conventional NFC antennas can be wrapped around the display of the mobile terminal. Thus, in order to read/write a tag embedded in an object, the object must substantially obscure the display, thereby making the display difficult to view. Another conventional approach is to embed the NFC antenna within a battery cover on the back of the mobile terminal, thereby interfering with the portion of the housing typically used for gripping the device.

### SUMMARY

In one aspect, the invention is embodied in mobile computer. The mobile computer includes a memory for storing a software application. A processor is coupled to the memory for executing the software application. A display is coupled to the processor for graphically displaying information generated by the software application. A card reader having a slot is coupled to the processor for receiving input from a data card. A radio frequency identification (RFID) antenna is embedded in a portion of the card reader proximate to the slot. The RFID antenna includes at least one conductor that forms at least one loop for communicating with an RFID device positioned at least partially within the slot.

In one embodiment, the mobile computer also includes a security access module (SAM) slot for receiving a security access card. The card reader can be a magnetic stripe reader, a barcode reader, a smart card reader, an access control card reader, or a proximity card reader. In one embodiment, the RFID device includes a RFID tag.

The mobile computer can also include a keypad located adjacent to the display. The keypad can include an input control. The antenna including at least one conductor can include a pair of conductors that form first and second concentric loops. The mobile computer can include a housing for supporting the memory, the processor, the display, the card reader, and the RFID antenna.

In one embodiment, the conductor includes a conductive trace deposited on a surface of the housing proximate to the card reader. The display includes a liquid crystal display (LCD). In alternate embodiments, the conductor includes a wire or a conductive trace formed on a printed circuit board (PCB). A RFID transceiver can be coupled to the RFID antenna for communicating wirelessly with the RFID device.

In another aspect, the invention is embodied in a card reader. The card reader includes a housing. A slot is formed in the housing. A data card reading device is supported in the slot. A processor is coupled to the data card reading device. A RFID antenna is embedded in a portion of the housing proximate to the slot. The RFID antenna includes at least one conductor forming at least one loop for communicating with an RFID device positioned at least partially within the slot.

The card reader can also include a memory coupled to the processor for storing data from the data card reading device. The data card reading device can include a magnetic stripe reading head, a barcode scanner, a smart card reading device, an access control card reading device, or a proximity card reading device.

In one embodiment, one or more security access module (SAM) slot is formed in the housing for receiving a security access card. The RFID device includes a RFID tag. The conductor of the antenna can include a pair of conductors that form first and second concentric loops. The conductor can include a wire. In another embodiment, the conductor includes a conductive trace deposited on a surface of the housing. In one embodiment, a RFID transceiver is coupled to the RFID antenna for communicating wirelessly with the RFID device.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments.

In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a block diagram illustrating an exemplary mobile computer including a data card reader having an embedded antenna according to an embodiment of the invention.

FIG. 2 is a rear perspective view of a mobile computer including a data card reader having an embedded RFID antenna according to an embodiment of the invention.

FIG. 3 is another rear perspective view of a mobile computer including a data card reader having an embedded RFID antenna according to an embodiment of the invention.

FIG. 4 is a front perspective view of a mobile computer including a data card reader having an embedded RFID antenna according to an embodiment of the invention.

FIG. 5 is a front perspective view of another mobile computer including a data card reader having an embedded RFID antenna according to an embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to near field radio-frequency identification technology, need not, and are not, described in detail herein.

Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions described herein. The non-processor circuits may include, but are not limited to, a radio receiver, a radio transmitter, signal drivers, clock circuits, power source circuits, and user input devices. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

The embodiments described herein relate to a near field communication (NFC) antenna embedded in a housing of a mobile computer proximate to a card reader for receiving information from a data card of a user. For example, the NFC antenna may be used to collect payment, process tickets, coupons, or other information or transaction from a user.

In one exemplary embodiment, a mobile computer includes a data card reader module having a NFC antenna proximate thereto. In one embodiment, the NFC antenna can be disposed on a surface of the housing of the data card reader module, or the antenna can be embedded in a portion of the housing.

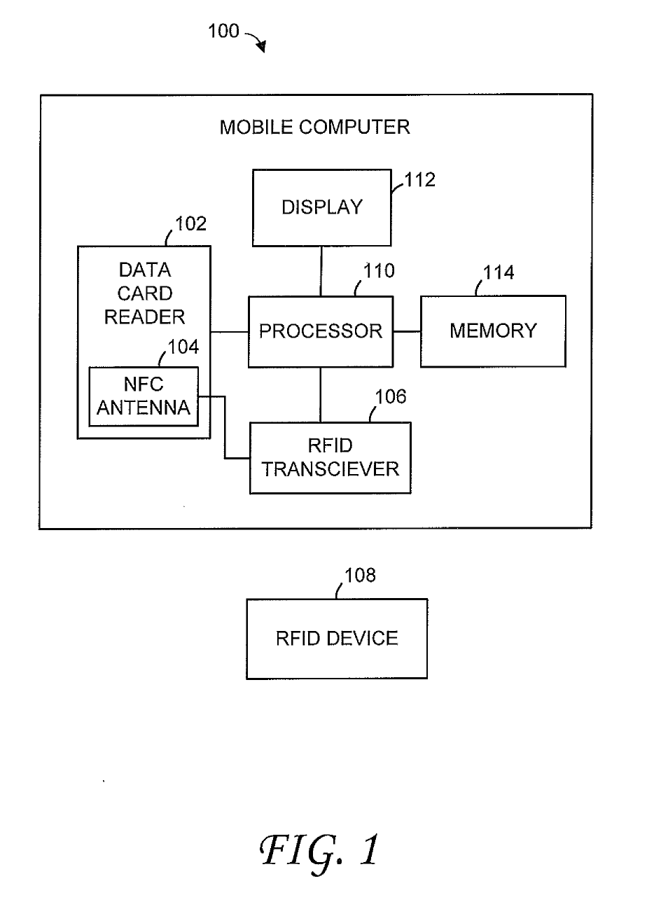

FIG. 1 is a block diagram illustrating an exemplary mobile computer 100 including a data card reader 102 having a NFC antenna 104 according to an embodiment of the invention. In one embodiment, the data card reader 102 also includes a slot (not shown). A data card reading device (not shown), such as a magnetic reading head can be located within the slot.

The mobile computer 100 also includes a RFID transceiver 106 that receives signals from the NFC antenna 104 and transmits signals to a RFID device 108 via the NFC antenna 104. The RFID device 108 can be a RFID tag. For example, the RFID tag can be embedded in a smart card, an identification card, a passport, a key fob, and a wallet.

The NFC antenna 104 can be embedded in a portion of the data card reader 102. In one embodiment, the data card reader 102 is a magnetic stripe reader that can read the magnetic stripe on a credit or debit card. The antenna 104 is positioned so as to be capable of communicating with an RFID device 108, such as a smart card that is positioned at least partially in the slot of the data card reader 102. In one embodiment, the antenna 104 includes a conducting loop that is disposed proximate to the slot. The antenna 104 is described in more detail herein. The RFID transceiver 106 is coupled to the antenna 104 and receives signals received from the RFID device 108 via the antenna 104. For example, the RFID transceiver 106 can receive transaction information, such as the account data and an identifier from the RFID device 108. In one embodiment, the mobile computer 100 can transmit information associated with the RFID device 108 to a remote device, such as a server.

A processor 110 can direct a display 112 to display information related to the RFID device 108, such as transaction information. The display 112 can be any suitable graphical display, such as a liquid crystal display (LCD) that can include a thin film transistor (TFT) material. The display 112 can include touch screen capabilities.

The processor 110 can control the operation of the RFID transceiver 106 by executing a software application stored in memory 114. The memory 114 can be any suitable memory, such as a random access memory (RAM), read only memory (ROM), flash memory or a secure disk (SD) card memory.

In one embodiment, the RFID transceiver 106 and the processor 110 can be semiconductor components mounted on a printed circuit board within the mobile computer 100. In an alternate embodiments, the RFID transceiver 106 and the processor 110 and any other electronic components of the mobile computer 100 can be separate components.

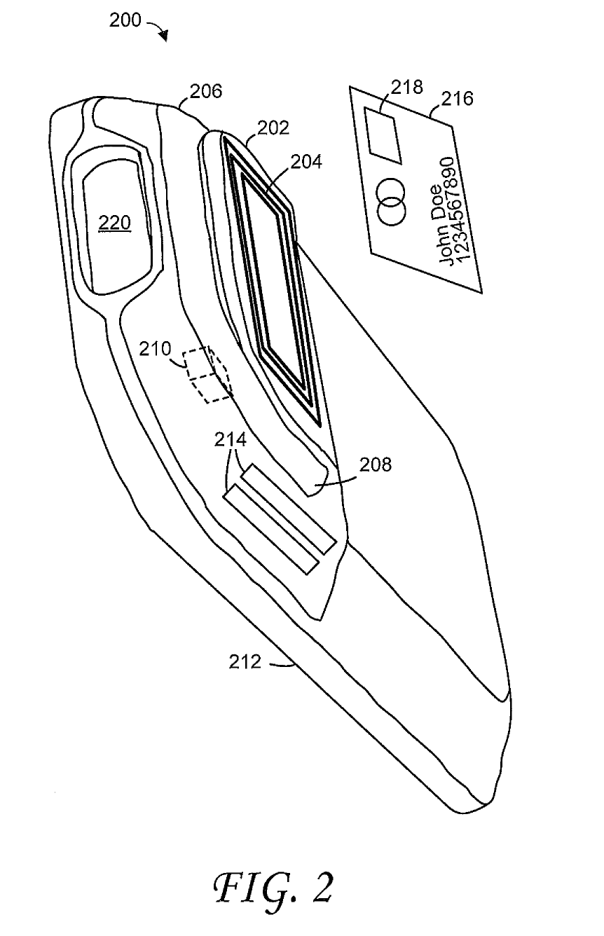

FIG. 2 is a rear perspective view of a mobile computer 200 including a card reader 202 having an embedded NFC antenna 204 according to an embodiment of the invention. Alternatively, the NFC antenna 204 can be disposed on a portion of the card reader 202. The card reader 202 can be located on the back housing 206 of the mobile computer 200. In one embodiment, the antenna 204 is a conductor, such as a wire or a conductive trace deposited on the back housing 206 of the mobile computer 200 proximate to the card reader 202.

In one embodiment, the card reader 202 can include a slot 208. A data card reading device 210 is supported in the slot 208. The data card reading device 210 can include a magnetic stripe reading head, a barcode scanner, a smart card reading device, an access control card reading device, or a proximity card reading device, for example.

The mobile computer 200 also includes a display (not shown). The display can be a touch screen display. In one embodiment, the display can be assembled within the front housing 212 of the mobile computer 200.

The mobile computer 200 and/or the card reader 202 can also include one or more security access module (SAM) slots 214 for receiving a security access card.

An RFID device 216 including a RFID tag 218 can be positioned proximate to the RFID antenna 204 to communicate with the RFID antenna 204. For example, the RFID device 216 can communicate with the antenna 204 when the RFID device 216 is positioned at least partially in the slot 208. In practice, the RFID device 216 can communicate with the antenna 204 whenever it is positioned in range of the antenna 204.

The display can graphically display information relating to the communication with the RFID device 216. The mobile computer 200 can also include a data acquisition device 220. The data acquisition device 220 can be a barcode scanner, such as an imager or a laser scanner, for example.

In operation, a user moves the RFID device 216 through the slot. The RFID tag 218 communicates with the NFC antenna 204 when the RFID tag 218 is positioned in range of the NFC antenna 204. In one embodiment, the RFID device 216 also includes a magnetic data stripe that can be read by the data card reading device 210 when the RFID device 216 passes through the slot 208. For example, the RFID device 216 can embody a credit or debit card.

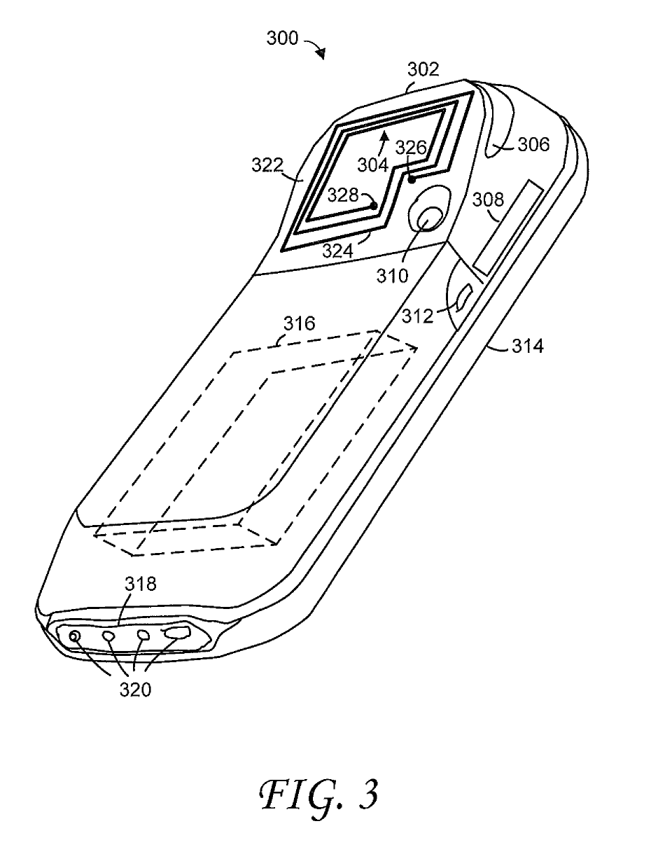

FIG. 3 is rear perspective view of another mobile computer 300 including a data card reader 302 having an embedded RFID antenna 304 according to an embodiment of the invention. The data card reader 302 can include a slot 306. A reading device (not shown) is supported in the slot 306 of the data card reader 302. The data card reader 302 can also include one or more Security Access Module (SAM) slots 308 that accept security access cards.

The mobile computer 300 can also include a camera 310. The camera 310 can be used to capture images. One or more input controls 312 can be positioned on the housing 314 of the mobile computer 300.

The mobile computer 300 can include a battery 316 for powering components of the mobile computer 300. The mobile computer 300 can include a connector 318 having one or more contacts 320. The contacts 320 can provide power and/or data to the mobile computer 300. In one embodiment, the connector 318 mates with a connector (not shown) of a charging cradle (not shown). The charging cradle can be configured to charge the battery 316 and/or to transfer data to and from the mobile computer 300.

In one embodiment, the antenna 304 can be integrated in the back housing 322 of the mobile computer 300. The antenna 304 can include a conductor 324 that forms concentric loops. The conductor 324 can include a feed point 326 and a ground point 328. In one example, the conductor 324 can be a trace of a metal oxide material that is deposited on a surface of a printed circuit board (not shown) or another substrate during the manufacturing process. In an alternate implementation, the conductor 324 can be a wire that is adhesively attached to a surface of the housing 322 of the mobile computer 300. In order to hide the conductor 324, the wire can be embedded in the housing 322. The feed point 326 of the conductor 324 can terminate at a connector (not shown) that mates with a connector (not shown), for connecting the NFC antenna 304 to the RFID transceiver 106 (FIG. 1). In an alternate embodiment, the antenna 304 can include one or more separate conductors (not shown) that form a plurality of concentric loops. In one embodiment, the RFID transceiver 106 can be integrated with the card reader 302 of the mobile computer 300.

The NFC antenna 304 can communicate with RFID devices, such as RFID-enabled credit cards, identification cards, fobs, or phones, via a magnetic or electric field. In one embodiment, eddy currents on a nearby ground plane (i.e., the card reader printed circuit board) can be produced by the antenna 304 when communicating with a RFID device 216 (FIG. 2) via a magnetic field. These eddy currents absorb power, and can lead to detuning of the antenna 304 due to a decreased inductance and quality factor. In order to reduce these eddy currents, a ferrite shield (not shown) can be placed over the conductors 324 to shield the antenna 304 from the metallic environment. The ferrite generates an additional field component, which results in a fixed detuning of the antenna 304 itself.

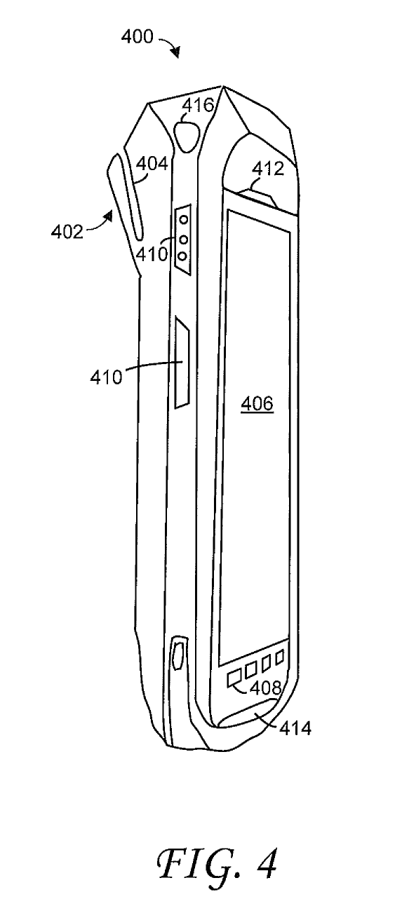

FIG. 4 is a front perspective view of a mobile computer 400 including a data card reader 402 having a NFC antenna (not shown) according to an embodiment of the invention. The card reader 402 can include a slot 404 for accepting a data card, such as a credit card having a magnetic stripe.

The mobile computer 400 includes a display 406. The display 406 can be a touch screen display. The mobile computer 400 can also include one or more input controls 408, such as soft keys.

One or more controls 410 can be positioned on the sides of the housing of the mobile computer 400. The mobile computer 400 can include a speaker 412 and a microphone 414. The mobile computer 400 can also include a headphone jack 416 for connecting a headphone to the mobile computer 400.

In operation, the display 406 can display a graphical indication that the user should position the RFID device 216 (FIG. 2) in the slot 404 of the card reader 402. Additionally, the display 406 can illustrate advertisements, coupons, or other information relating to a transaction with the RFID device 216.

When the user passes the RFID device 216 through the slot 404 in the data reader 402, the antenna 204 (FIG. 2) can read transaction information from the RFID device 216 and/or write information to the RFID device 216. The display 406 can display status information to the user. For example, the status information can relate to whether the RFID device 216 was properly read by the mobile computer 400 and/or written to or by the mobile computer 400.

Additionally, the user can be prompted for additional information. For example, the user could be prompted to enter a personal identification number (PIN) or a date of birth using a keypad (not shown) or a touch screen of the display 406. During a commercial transaction, the mobile computer 400 can transmit the information to a credit card issuer to effect the payment transaction.

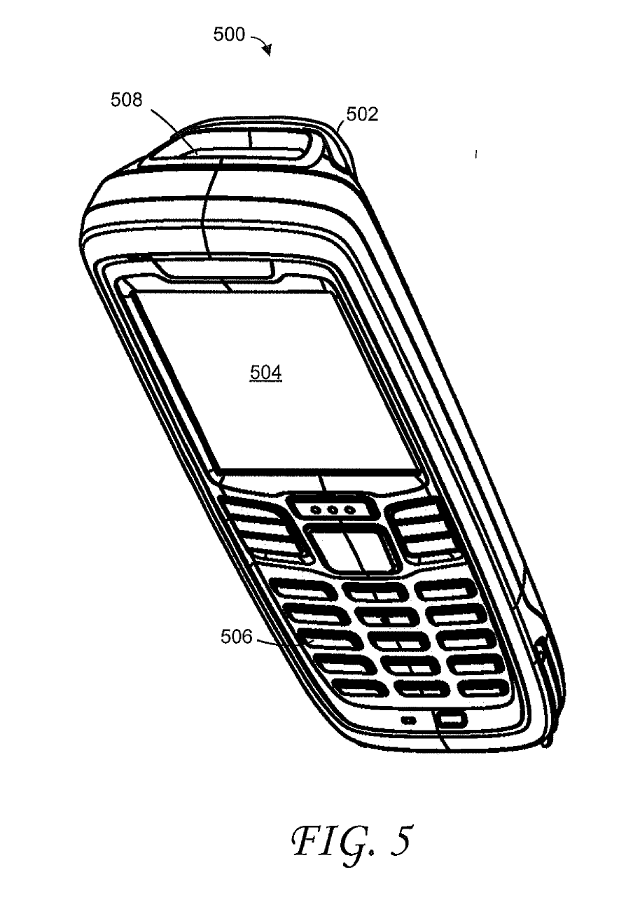

FIG. 5 is a front perspective view of another mobile computer 500 including a data card reader 502 having an embedded RFID antenna (not shown) according to an embodiment of the invention. The mobile computer 500 includes a display 504 and a keypad 506. In one embodiment, the mobile computer 500 also includes a data acquisition device 508, such as a barcode scanner or an imager.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A mobile computer comprising:
a memory for storing a software application;
a processor coupled to the memory for executing the software application;
a display coupled to the processor for graphically displaying information generated by the software application;
a card reader having a slot coupled to the processor for receiving input from a data card; and
a RFID antenna embedded in a portion of the card reader proximate to the slot, the RFID antenna comprising at least one conductor forming at least one loop for communicating with an RFID device positioned at least partially within the slot.

2. The mobile computer of claim 1, further comprising a security access module (SAM) slot for receiving a security access card.

3. The mobile computer of claim 1, wherein the card reader is chosen from the group comprising a magnetic stripe reader, a barcode reader, a smart card reader, an access control card reader, and a proximity card reader.

4. The mobile computer of claim 1, wherein the RFID device comprises a RFID tag.

5. The mobile computer of claim 1, further comprising a keypad located adjacent to the display.

6. The mobile computer of claim 1, wherein the at least one conductor comprises a pair of conductors that form first and second concentric loops.

7. The mobile computer of claim 1 further comprising a housing for supporting the memory, the processor, the display, the card reader, and the RFID antenna.

8. The mobile computer of claim 7, wherein the at least one conductor comprises a conductive trace deposited on a surface of the housing proximate to the card reader.

9. The mobile computer of claim 1, wherein the display comprises a liquid crystal display (LCD).

10. The mobile computer of claim 1, wherein the at least one conductor comprises one of a wire and a conductive trace formed on a printed circuit board (PCB).

11. The mobile computer of claim 1, further comprising a RFID transceiver coupled to the RFID antenna for communicating wirelessly with the RFID device.

12. A card reader comprising:
a housing;
a slot formed in the housing;
a data card reading device supported in the slot;
a processor coupled to the data card reading device; and
a RFID antenna embedded in a portion of the housing proximate to the slot, the RFID antenna comprising at least one conductor forming at least one loop for communicating with an RFID device positioned at least partially within the slot.

13. The card reader of claim 12, further comprising a memory coupled to the processor for storing data from the data card reading device.

14. The card reader of claim 12, wherein the data card reading device is chosen from the group comprising a magnetic stripe reading head, a barcode scanner, a smart card reading device, an access control card reading device, a proximity card reading device.

15. The card reader of claim 12, further comprising a security access module (SAM) slot formed in the housing for receiving a security access card.

16. The card reader of claim 12, wherein the RFID device comprises a RFID tag.

17. The card reader of claim 12, wherein the at least one conductor comprises a pair of conductors that form first and second concentric loops.

18. The card reader of claim 12, wherein the at least one conductor comprises one of a wire and a conductive trace formed on a printed circuit board (PCB).

19. The card reader of claim 12, wherein the at least one conductor comprises a conductive trace deposited on a surface of the housing.

20. The card reader of claim 12, further comprising a RFID transceiver coupled to the RFID antenna for communicating wirelessly with the RFID device.
